(19) United States
(12) Patent Application Publication
(10) Pub. No.: US 2025/0190849 A1
(43) Pub. Date: Jun. 12, 2025

(54) MAINTAINING SEQUENTIALITY FOR A COUNTER FOR SEQUENTIAL LEARNING

(71) Applicant: Capital One Services, LLC, McLean, VA (US)

(72) Inventors: Venkateshwar PARPELLI, Frisco, TX (US); Yang CHEN, Frisco, TX (US); Luke KIOWSKI, Chicago, IL (US)

(21) Appl. No.: 18/533,700

(22) Filed: Dec. 8, 2023

(51) Int. Cl. G06N 20/00

(52) U.S. Cl. CPC G06N 20/00

(57) ABSTRACT

In some implementations, a device may receive, via a feedback stream, one or more feedback instances associated with a machine learning model. The device may update a counter to obtain counter values for respective feedback instances of the one or more feedback instances based on performing atomic operations for the respective feedback instances. The device may provide, via a data stream, the counter values to a first-in-first-out (FIFO) queue to be written in an order of completion of the atomic operations. The device may store the one or more feedback instances in connection with respective counter values based on obtaining the counter values from the FIFO queue in the order of completion. The device may perform, using the one or more feedback instances, one or more training operations for the machine learning model.

### BACKGROUND

Machine learning involves computers learning from data to perform tasks. Machine learning algorithms are used to train machine learning models based on sample data, known as “training data.” Once trained, machine learning models may be used to make predictions, decisions, or classifications relating to new observations. Machine learning algorithms may be used to train machine learning models for a wide variety of applications, including computer vision, natural language processing, financial applications, medical diagnosis, and/or information retrieval, among many other examples. In some examples, a machine learning algorithm may be trained via sequential learning. Sequential learning may refer to a process of continuously updating and improving a performance of the machine learning algorithm as new data is encountered over time (e.g., enabling the machine learning algorithm to evolve predictions and/or behaviors in response to changing inputs).

### SUMMARY

Some implementations described herein relate to a system for maintaining sequentiality for a counter for sequential learning. The system may include one or more memories and one or more processors communicatively coupled to the one or more memories. The one or more processors may be configured to receive, via a feedback stream, one or more requests to perform respective operations for feedback data associated with a machine learning model, wherein processing units are associated with respective requests of the one or more requests and are configured to perform the respective operations. The one or more processors may be configured to update, via a counter database, the counter to obtain counter values for the respective requests of the one or more requests based on performing atomic operations for the respective requests. The one or more processors may be configured to provide, from the counter database and via a data stream, the counter values to a first-in-first-out (FIFO) queue to be written in an order of completion of the atomic operations. The one or more processors may be configured to store the feedback data in connection with respective counter values based on providing the counter values from the FIFO queue to the processing units in the order of completion. The one or more processors may be configured to perform, using the feedback data, one or more training operations for the machine learning model based on a counter value, of the counter values, satisfying a threshold.

Some implementations described herein relate to a method for maintaining sequentiality for feedback for sequential learning. The method may include receiving, by a device and via a feedback stream, one or more feedback instances associated with a machine learning model. The method may include updating, by the device, a counter to obtain counter values for respective feedback instances of the one or more feedback instances based on performing atomic operations for the respective feedback instances. The method may include providing, by the device and via a data stream, the counter values to a FIFO queue to be written in an order of completion of the atomic operations. The method may include storing, by the device, the one or more feedback instances in connection with respective counter values based on obtaining the counter values from the FIFO queue in the order of completion. The method may include performing, by the device and using the one or more feedback instances, one or more training operations for the machine learning model.

Some implementations described herein relate to a non-transitory computer-readable medium that stores a set of instructions. The set of instructions, when executed by one or more processors of a device, may cause the device to obtain, via a request stream, one or more requests associated with a data element included in a distributed database, wherein processing units of the device are associated with respective requests of the one or more requests and are configured to perform the one or more requests. The set of instructions, when executed by one or more processors of the device, may cause the device to update, for each request of the one or more requests, a counter to obtain a counter value for that request based on performing an atomic operation associated with the counter for that request. The set of instructions, when executed by one or more processors of the device, may cause the device to provide, via a data stream, counter values to a FIFO queue to be written sequentially in accordance with an order of counter values. The set of instructions, when executed by one or more processors of the device, may cause the device to provide, from the FIFO queue and in the order, the counter values to respective processing units of the processing units. The set of instructions, when executed by one or more processors of the device, may cause the device to perform, via the processing units, one or more operations associated with the respective requests based on providing the counter values.

### BRIEF DESCRIPTION OF THE DRAWINGS

FIGS. 1A-1C are diagrams of an example associated with maintaining sequentiality for a counter for sequential learning, in accordance with some embodiments of the present disclosure.

FIG. 2 is a diagram of an example process associated with maintaining sequentiality for a counter for sequential learning, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of a device associated with maintaining sequentiality for a counter for sequential learning, in accordance with some embodiments of the present disclosure.

FIG. 5 is a flowchart of an example process associated with maintaining sequentiality for a counter for sequential learning, in accordance with some embodiments of the present disclosure.

### DETAILED DESCRIPTION

The following detailed description of example implementations refers to the accompanying drawings. The same reference numbers in different drawings may identify the same or similar elements.

In some computing environments, distributed databases may enable systems to handle large volumes of data efficiently and/or may ensure high availability of the data stored by the distributed databases. In a distributed environment, multiple threads or containers may be utilized to interact with the distributed database. For example, querying and/or accessing of a distributed database may occur via separate threads. A “thread” may refer to a single sequence stream within a process (e.g., an independent sequence of instructions within a program that can be executed concurrently). For example, a thread may be a given execution path. A thread may also be referred to as a “processing unit.” For example, a thread may refer to a fundamental unit of execution within a computer program or process. Threads may be lightweight, independent sequences of instructions that operate concurrently within a single process, sharing the same memory space and resources. Each thread can execute independent instructions, perform calculations, and/or manipulate data independently of other threads executing in the same process. A thread may be, or may be associated with, a container, a serverless function (e.g., a Lambda function), or another component of a cloud computing environment.

In distributed environments (e.g., cloud computing environments), multiple threads may access the same distributed database at the same time or at similar times (e.g., may access the same distributed database concurrently). As another example, a device may include a set of cores (e.g., a processing unit within a central processing unit (CPU). Each core may be separate and independent processing unit capable of executing instructions and performing computations. In some examples, the device may include a large quantity of cores. The large quantity of cores may increase a likelihood of concurrent operations being performed by respective cores. For example, multiple threads may cause an action to be performed for the same data in the distributed database concurrently (e.g., each thread may perform an action associated with the same field or entry in the distributed database). As an example, multiple threads may attempt to update the same value in the distributed database at the same time or at overlapping times. For example, each thread may read a value from the distributed database. The multiple threads may independently update the value to generate respective updated values. The multiple threads may attempt to store the respective updated values in the distributed database. However, because the threads may have read and updated the value at the same time or at overlapping times, the operation(s) performed by the multiple threads may be inaccurate, may result in duplicate processing of the value, and/or may result in data being missed or incorrectly stored in the distributed database.

For example, the value may be a counter value (e.g., that is associated with maintaining a sequentiality of data stored in the distributed database). As an example, a value of the counter stored in the distributed database may be N. “Value of the counter” and “counter value” may be used interchangeably herein. Each thread may read the value N from the distributed database and independently increment the value, such that each thread generates an updated counter value of N+1. As a result, when data is written to the distributed database by the multiple threads, this may result in data being overwritten because each thread may write the counter value of N+1 to the distributed database, rather than each thread writing an independent and sequential counter value to identify the data and/or operation associated with that thread. For example, if multiple threads include three threads (e.g., a first thread, a second thread, and a third thread), the first thread may write the counter value N+1, the second thread may also write the counter value of N+1 rather than a counter value of N+2 (e.g., resulting in data associated with the first thread being overwritten and/or lost), and the third thread may also write the counter value of N+1 rather than a counter value of N+3 (e.g., resulting in data associated with the second thread being overwritten and/or lost). As a result, a sequentiality of data stored in the distributed database may not be maintained and/or data in the distributed database may be overwritten. This may result in processing resources, network resources, and/or memory resources, among other examples, being consumed in association with performing additional processing to re-write overwritten data and/or to correct the sequentiality of the data in the distributed database.

In some examples, the distributed database may store data used for sequential learning for a machine learning model. For example, the distributed database may store feedback data used for a sequential learning operation for the machine learning model. As described elsewhere herein, sequential learning may be associated with training and/or updating the machine learning model using data that arrives in a sequential order. Sequential learning may also be referred to as online learning, and/or incremental learning, among other examples. However, using data with incorrect sequentiality may result in degraded performance of the sequential learning operation. For example, sequential data may contain temporal dependencies, where the order of data points carries meaningful information. Additionally, data distribution can change over time (referred to as concept drift). Maintaining the sequential order of data enables the machine learning model to detect and adapt to these changes as they occur. Further, sequential learning is often used in real-time or dynamic environments where new data arrives continuously. Machine learning models may need to adapt quickly to new information. By preserving the sequentiality of data, the machine learning model can update a knowledge base incrementally, making the machine learning model well-suited for applications such as fraud detection, recommendation systems, and/or anomaly detection, among other examples. As another example, sequential learning may be used for reinforcement learning, where agents make decisions based on the sequence of states, actions, and/or rewards. Reinforcement learning models rely on the sequentiality of data to learn optimal strategies and policies over time. As another example, anomaly detection may rely on identifying deviations from established patterns. Sequential data may help the machine learning model recognize when a sequence of observations becomes anomalous, thereby improving applications such as network security and fault detection. As a result, a lack of sequentiality for the data used in a sequential learning operation may degrade the ability of the machine learning model to capture temporal dependencies, adapt to changing environments, and/or make real-time decisions, among other examples. This may degrade the ability of the machine learning model to continuously learn and improve.

Some implementations described herein enable maintaining sequentiality for a counter in a distributed environment. In some implementations, a counter management device may enable sequentiality to be maintained for a counter for a sequential learning operation (e.g., of a machine learning model). In some implementations, the counter management device may utilize a locking mechanism to update concurrent requests associated with updating a value in a distributed database and may stream updated values to a first-in-first-out (FIFO) queue to maintain the sequentiality of the values for the concurrent requests. As an example, the locking mechanism may include storing the value in a separate table as an atomic field and updating the values using an atomic expression (e.g., which may result in a row in which the value is stored being locked, reducing the likelihood of overwriting by the concurrent requests). As used herein, an “atomic” operation may refer to an operation that is indivisible, unchangeable, and guaranteed to be executed without interruption by other operations. The counter management device may stream the updated values to a FIFO queue. Processing units (e.g., threads) may read the update values from the FIFO queue to ensure that each processing unit (e.g., that is associated with parallel or concurrent processing for the value) obtains a unique and/or sequential value to be associated with one or more operations performed by that processing unit.

For example, the counter management device may receive, via a feedback stream, one or more requests to perform respective operations for feedback data associated with a machine learning model. The one or more requests may be associated with respective feedback instances (e.g., for sequential learning for the machine learning model). A request may be a request to store feedback data in a distributed database. The processing units may be associated with respective requests of the one or more requests and are configured to perform the respective operations. The counter management device may update, via a counter database, the counter to obtain counter values for the respective requests of the one or more requests based on performing atomic operations for the respective requests. The counter management device may provide, from the counter database and via a data stream, the counter values to a FIFO queue to be written in an order of completion of the atomic operations. The counter management device may store the feedback data in connection with respective counter values based on providing the counter values from the FIFO queue to the processing units in the order of completion. In some implementations, the counter management device may perform, using the feedback data, one or more training operations (e.g., one or more sequential learning operations) for the machine learning model based on a counter value, of the counter values, satisfying a threshold. For example, the one or more training operations may be associated with sequential unsupervised learning for the machine learning model.

As a result, the counter management device may ensure that sequentiality for values stored for the counter is maintained. Additionally, by updating the counter value using the locking mechanism and streaming to the FIFO queue, the counter management device may ensure that data is not lost or overwritten by concurrent or parallel processing (e.g., performed by respective threads or processing units) for the same counter value. This may conserve processing resources, network resources, and/or memory resources, among other examples, that would have otherwise been associated with performing additional processing to re-write overwritten data and/or to correct the sequentiality of the data in the distributed database. Further, by ensuring that the sequentiality of a counter value identifying different data in the distributed database (e.g., a counter value indicating a sequence of feedback data for the machine learning model) is maintained, the counter management device may improve the performance of one or more sequential learning operations for the machine learning model.

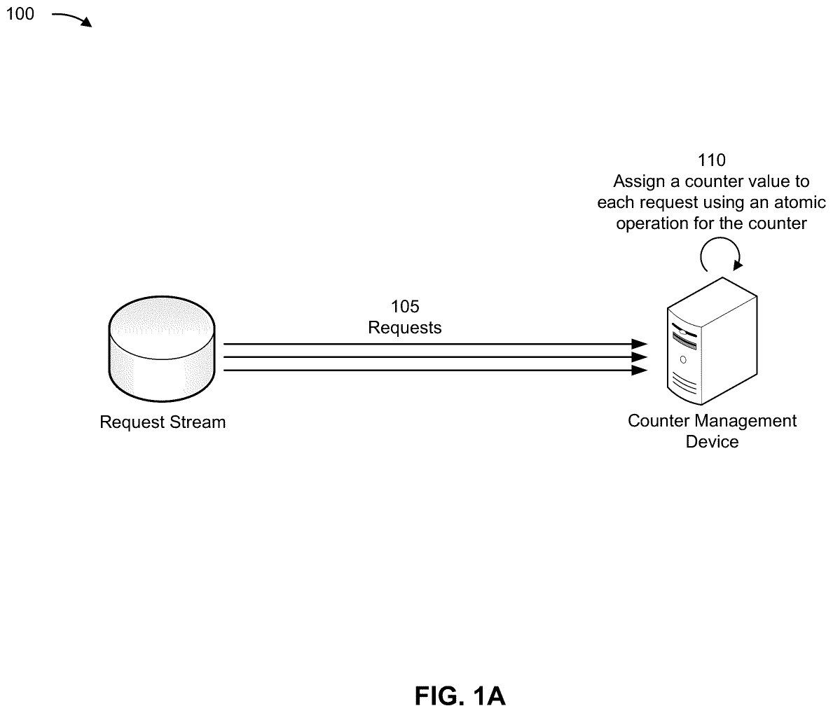

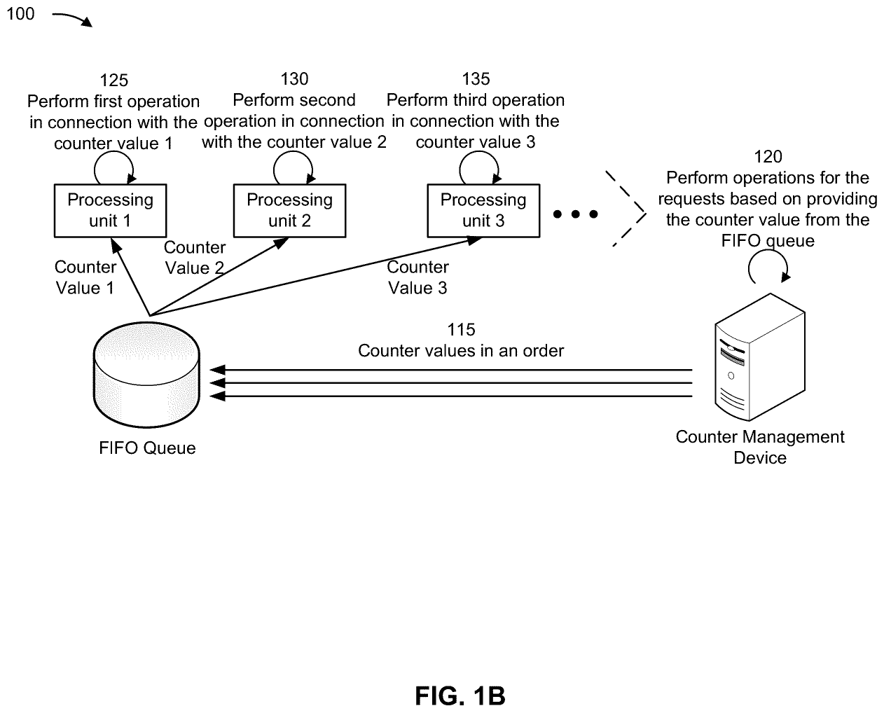

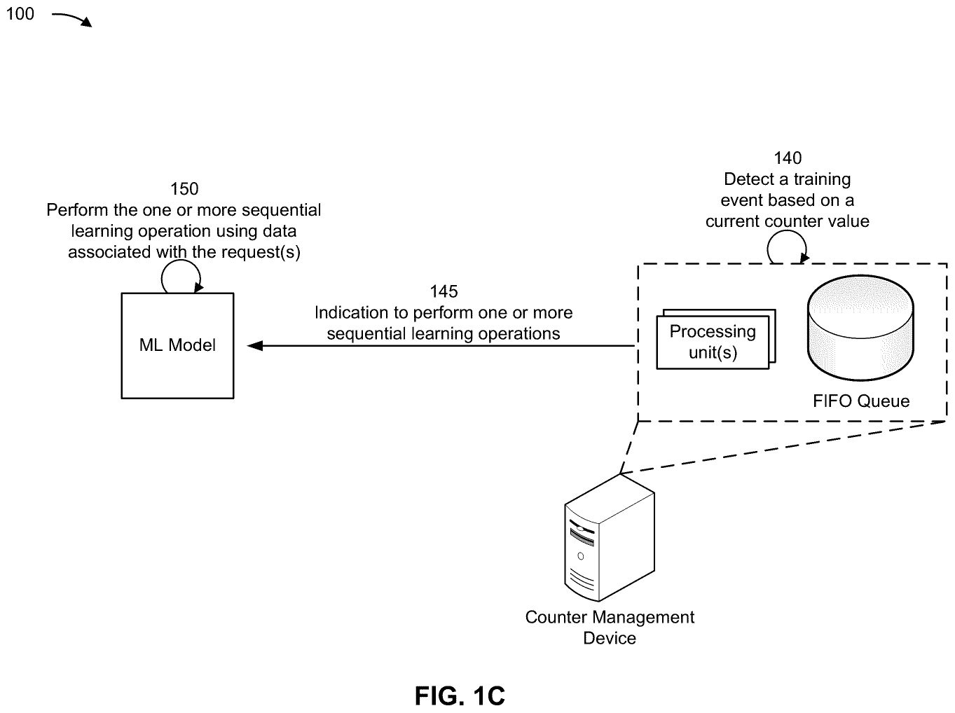

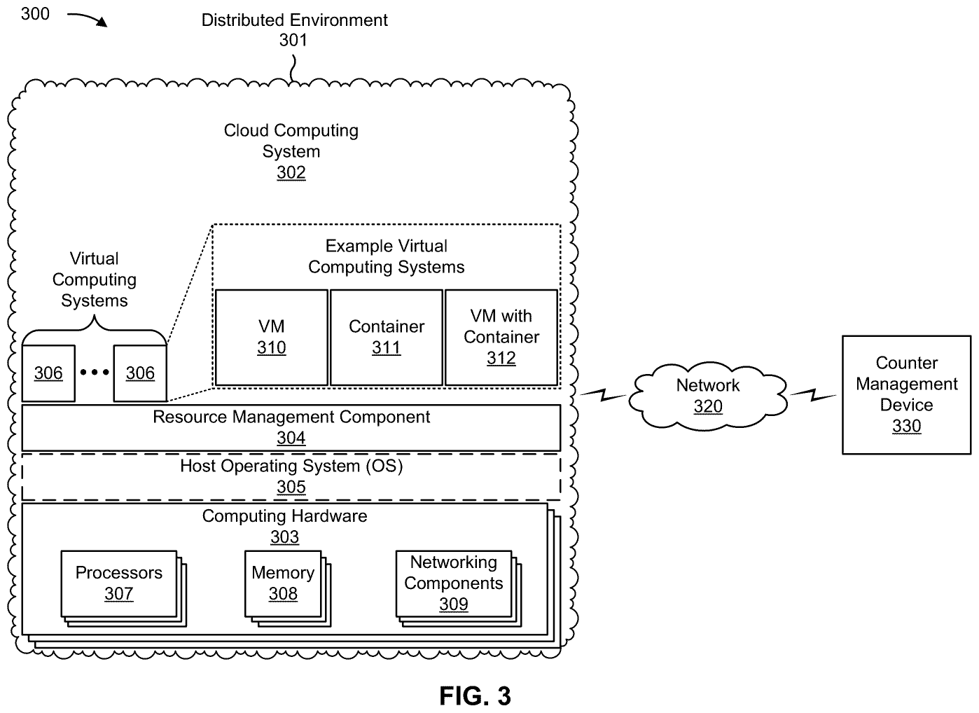

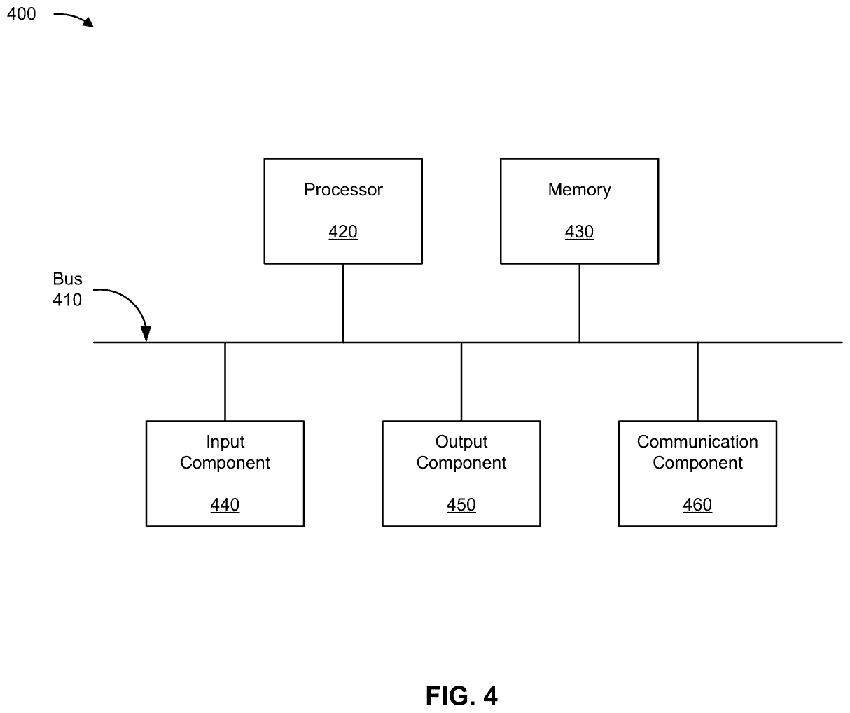

FIGS. 1A-1C are diagrams of an example 100 associated with maintaining sequentiality for a counter for sequential learning. As shown in FIGS. 1A-1C, example 100 includes a counter management device, a request stream (e.g., associated with one or more processing units), and a FIFO queue. These devices are described in more detail in connection with FIGS. 3 and 4.

As shown in FIG. 1A, and by reference number 105, the counter management device may obtain one or more requests via the request stream. The request stream may be a data stream to convey requests from respective processing units (e.g., threads) associated with a distributed database. For example, the distributed database may be associated with storing data associated with a machine learning model. As an example, the distributed database may store feedback data associated with the machine learning model. The counter management device may be associated with maintaining a counter that tracks a sequentiality and/or a quantity of instances of feedback data for the machine learning model. In such examples, the request stream may be referred to as a feedback stream.

For example, the request stream may stream requests from different processing units to the counter management device. The request steam may enable the counter management device to update and/or manage requests in real time. For example, the request stream may provide (e.g., stream) requests to the counter management device as the requests arrive.

The requests may be associated with performing respective operations (e.g., a data processing operation) for the distributed database. For example, the operations may be associated with the same row, field, and/or entry of the distributed database. As an example, the requests may be associated with updating a field or entry that stores a current counter value. For example, a processing unit may be associated with storing an instance of feedback data (e.g., feedback associated with an output of the machine learning model) and updating the counter to indicate an order and/or identifier for the feedback data. Although some examples are described herein in connection with updating a counter value in a distributed database, the techniques and implementations described herein may be similarly applied to updating or maintaining any data, field, or entry in a distributed database (e.g., where concurrent and/or parallel processing requests are associated with accessing or modifying the same data, field, or entry).

The counter management device may be, or may include, a listener configured to monitor and/or process incoming events (e.g., requests) from the request stream. For example, the listener may be a component of the counter management device. The listener may subscribe to a request queue (e.g., the request stream). When a request is published to the request queue (e.g., and is associated with updating the counter), the listener may obtain and/or process the request. For example, the listener may be configured to monitor for requests associated with updating the counter for feedback data associated with the machine learning model. The counter management device may receive and/or obtain the requests via the listener.

As shown by reference number 110, the counter management device may assign a counter value to each request using an atomic operation for the counter. For example, the counter management device may update, via a counter database, the counter to obtain counter values for the respective requests of the one or more requests based on performing atomic operations for the respective requests. The counter database may be a distributed database in which a current counter value is stored. For example, the current counter value may be stored in a field of the counter database as an atomic number.

The counter management device may update the atomic number via an expression. For example, the counter management device may perform a counter update using an expression function and an atomic value. The atomic value may be a current counter value. For example, the expression may include an update expression. The update expression may include an increment operation associated with an existing numeric attribute (e.g., the atomic number). The increment operation may be “atomic” in that the update expression may include the counter management device reading the current counter value, locking the counter value (e.g., to prevent other threads or entities from editing the counter value), incrementing the counter value (e.g., adding or subtracting a given value), and releasing the lock of the counter value. For example, the counter management device may perform, for each request of the one or more requests, an atomic increment using an atomic number as a current counter value and an expression to obtain a counter value for that request.

The counter values may be unique identifiers indicating an order (or sequentiality) associated with data and/or operations performed in association with the requests. For example, the counter values may be unique identifiers for respective feedback instances of one or more feedback instances associated with respective requests. The counter values may enable the counter management device to maintain a sequentiality of the one or more feedback instances (e.g., when the one or more feedback instances arrive via processing units that are associated with parallel processing in the distributed environment).

By updating the counter using an atomic number and/or expression, the counter management device may utilize a locking mechanism while updating the counter. For example, because the counter value is stored as an atomic number, while the atomic number is being updated for one request, the counter management device and/or another device may be unable to access and/or modify the counter value. This may ensure that multiple requests are not associated with the same counter value.

As shown in FIG. 1B, and by reference number 115, the counter management device may provide, from the counter database and via a data stream, counter values to a FIFO queue to be written in an order of completion of the atomic operations. For example, when updating the counter value (e.g., as described in connection with reference number 115), the counter management device may generate an event that causes the updated counter value to be automatically streamed to the FIFO queue.

For example, the distributed environment may include a serverless framework The serverless framework may use one or more serverless functions to perform tasks. A serverless function may be code that runs in an environment and is executed in response to a specific trigger or event. A serverless function may be referred to interchangeably herein as a lambda function and/or an anonymous function. The serverless function may be stateless, meaning that the serverless function does not retain any data or state between invocations. This allows the serverless function to scale horizontally and be triggered multiple times concurrently without interference.

Additionally, the serverless function may be managed by a cloud provider associated with the cloud computing environment. Therefore, developers (e.g., associated with developing the task or service) may not need to provision or maintain servers or infrastructure associated with performing the task or service. Instead, the developers can simply upload code and configure the triggers and events that will invoke the serverless function and the cloud provider may handle provisioning resources and infrastructure associated with executing the code via the serverless function. A given serverless function may be referred to as an instance of a serverless function. Serverless functions may be cost effective because the developers may only be charged (e.g., for use by the cloud provider) for the duration of the function execution and will not incur any charges when serverless functions are not running. This makes serverless functions well-suited for applications that require frequent, short-duration executions, such as data stream processing, among other examples.

When using a serverless framework, developers may write code that runs in response to specific events, such as a change in the counter value. The cloud provider may be responsible for running and scaling the code, as well as providing the necessary resources and/or infrastructure, such as memory and computing power, among other examples. Because serverless frameworks may only charge for the specific resources and computing time used, a serverless framework can be a cost-effective solution for applications that have unpredictable workloads or experience sudden spikes in traffic (e.g., a cloud provider only charges an entity for the cloud resources actually used). Additionally, serverless frameworks also provide built-in high availability and auto-scaling capabilities, so a task can automatically scale up or down based on the number of requests associated with the take, which can help ensure that the task is always available and responsive. One example of a serverless framework is the AMAZON WEB SERVICES (AWS®) LAMBDA framework.

For example, the counter management device may provide, to a serverless function, a counter value each time the counter value is updated. The serverless function may be configured to provide the counter value to the FIFO queue and/or to write the counter value in the FIFO queue. By updating the counter values using the atomic number and/or expression, the counter management device may ensure that the counter value is updated for each request and/or each operation associated with the distributed database (e.g., multiple threads may be unable to simultaneously update and/or write the same counter value). Further, by streaming the counter values to the FIFO queue as they are updated (e.g., via the serverless function), the counter management device may ensure that a sequentiality of the counter values is maintained (e.g., the FIFO queue may write the counter values in the order of competition of the update operation).

For example, each request may originate from a node in the distributed environment. The requests may be streamed from the nodes to the counter management device (e.g., as described in connection with reference number 105). The counter management device may update a value for the counter using a locking mechanism to ensure that the value is updated separately and for each request (e.g., the locking mechanism may include storing the counter value as an atomic number and using an update expression to update the value for each request). This may ensure that the value is updated once for each request (e.g., where the request may arrive concurrently and/or within a short period of time). The update of the counter value may cause the counter management device to generate an event for a data stream (e.g., for a serverless function). The event may cause the serverless function to stream the updated value to the FIFO queue (e.g., as described in connection with reference number 115). This may ensure that the updated values are stored in an order in which the updated values are generated (e.g., thereby ensure the sequentiality of the values for the counter).

In some implementations, in addition to providing the updated counter values, the counter management device may cause an indication of information in the distributed database to be streamed to the FIFO queue. For example, the counter management device may cause a “snapshot” of the distributed database (e.g., indicating information stored in the distributed database at the time the counter value is updated) to be streamed to and/or stored via the FIFO queue (e.g., in connection with a given counter value). This may enable a processing unit to perform one or more operations (e.g., data processing operations) using information stored in the distributed database at the time the counter value is updated to a given counter value, where the one or more operations will be tied to (e.g., associated with) the given counter value. For example, the processing unit (e.g., a thread) may obtain the counter value and the associated information stored in the distributed database at the time the counter value is updated and perform one or more operations using the information.

As shown by reference number 120, the counter management device may perform one or more operations for the requests based on providing the counter value(s) from the FIFO queue. For example, the counter management device may provide, from the FIFO queue and in the order in which the counter values are written in the FIFO queue, the counter values to respective processing units (e.g., threads). In some implementations, the processing units may be configured to obtain respective counter values from the FIFO queue. The FIFO queue may be configured to provide the counter values in the order in which the counter values are written in the FIFO queue.

For example, as shown in FIG. 1B, a first processing unit (processing unit 1) may obtain a first counter value (counter value 1) from the distributed database (e.g., as indicated by the FIFO queue). In some implementations, the first processing unit may obtain first information from the distributed database that is associated with the first counter value (e.g., from the FIFO queue). As shown by reference number 125, the first processing unit may perform a first operation in connection with the first counter value. For example, the first processing unit may store and/or generate a first feedback instance for the machine learning model (e.g., where the first feedback instance is stored in connection with the first counter value).

A second processing unit (processing unit 2) may obtain a second counter value (counter value 2) from the distributed database (e.g., as indicated by the FIFO queue). In some implementations, the second processing unit may obtain second information from the distributed database that is associated with the second counter value (e.g., from the FIFO queue). As shown by reference number 130, the second processing unit may perform a second operation in connection with the second counter value. For example, the second processing unit may store and/or generate a second feedback instance for the machine learning model (e.g., where the second feedback instance is stored in connection with the second counter value). A third processing unit (processing unit 3) may obtain a third counter value (counter value 1) from the distributed database (e.g., as indicated by the FIFO queue). In some implementations, the third processing unit may obtain third information from the distributed database that is associated with the third counter value. As shown by reference number 135, the third processing unit may perform a third operation in connection with the third counter value. For example, the third processing unit may store and/or generate a third feedback instance for the machine learning model (e.g., where the third feedback instance is stored in connection with the third counter value). Other processing units (e.g., threads) may obtain counter values from the distributed database (e.g., as indicated by the FIFO queue) and perform one or more operations in a similar manner.

For example, counter management device may perform, via the processing units, one or more operations associated with the respective requests based on providing the counter values from the FIFO queue. In some implementations, the counter management device may perform, via the processing units and based on providing the counter values from the FIFO queue to the processing units in the order of completion of the updates, respective operations for feedback data to cause the feedback data to be stored (e.g., in the distributed database or another distributed database). In some implementations, the operations may be concurrent operations. For example, different processing units may perform operations that at least partially overlap in time (e.g., where each operation is associated with a unique counter value).

For example, the counter management device may store feedback data (e.g., one or more instances of feedback data) in connection with respective counter values based on providing the counter values from the FIFO queue to the processing units in the order of completion. The counter values may be unique identifiers for respective sets of feedback data included in the feedback data to maintain a sequentiality of the feedback data. For example, each operation performed by a given processing unit may be associated with a given counter value (e.g., obtained via the FIFO queue). In this way, the operation(s) performed by the processing units may be uniquely identified and an order (or sequentiality) of operations performed by different processing units may be maintained.

As shown in FIG. 1C, and by reference number 140, the counter management device (e.g., via one or more processing units and/or the FIFO queue) may detect a training event based on a current counter value. For example, the training event may trigger one or more sequential learning operations for the machine learning model. The training event may include the current counter value satisfying a threshold. As another example, the training event may include the counter value being a multiple of a given value, such as 100 or another value.

As shown by reference number 145, the counter management device may provide (e.g., via one or more processing units and/or the FIFO queue) an indication to perform one or more sequential learning operations (e.g., based on or in response to detecting the training event). As shown by reference number 150, the machine learning (ML) model may perform the one or more sequential learning operations using data (e.g., feedback data) associated with the one or more requests. For example, the counter management device may perform (or may cause), using the feedback data, one or more training operations for the machine learning model based on a counter value satisfying a threshold and/or being a multiple of a given value. The one or more training operations may be associated with sequential unsupervised learning for the machine learning model.

For example, the counter management device and/or the machine learning model may perform the one or more training operations based on a sequential order of the feedback data indicated by the counter values. In other words, by ensuring the sequentiality of the counter values and ensuring that each operation performed by the processing units is associated with a unique counter value (e.g., as described in more detail elsewhere herein), the sequential learning operation(s) for the machine learning model may be performed using data (e.g., feedback data) with a higher likelihood of being sequential. By improving the likelihood that the data (e.g., feedback data) has a higher likelihood of being sequential, the performance of the sequential learning operation(s) may be improved.

In some implementations, the one or more sequential learning operations may include updating, using the feedback data, one or more precision metrics and/or a mean value associated with the machine learning model. A precision metric may indicate a proportion of true positive outputs (e.g., correctly identified positive instances of predictions or recommendations) out of all positive outputs made by the machine learning model. For example, the counter management device (or another device associated with the sequential learning operations) may analyze the feedback data to identify whether an output of the machine learning model was a true positive or a false positive. Using the feedback data, the counter management device (or another device associated with the sequential learning operations) may dynamically update the machine learning model. For example, one or more online learning algorithms enable the counter management device (or another device) to incrementally adjust one or more parameters and update a knowledge base of the machine learning model as new data arrives. For example, the counter management device (or another device) adjust a decision threshold of the machine learning model to optimize precision. By dynamically changing the threshold based on the feedback data, the counter management device (or another device) may control a trade-off between precision and recall (true positive rate).

The mean value associated with the machine learning model may refer to an average value of a specific variable or feature within a dataset used by the machine learning model. The counter management device (or another device) may dynamically update the mean value based on the feedback data. For example, the counter management device (or another device) may determine a new mean value based on a previous mean value, a number of observations (e.g., number of feedback instances and/or number of observations output by the machine learning model), and newly arrived data points (e.g., the feedback data).

Additionally, or alternatively, the one or more sequential learning operations may include resetting one or more gradients of the machine learning model. Resetting gradients in sequential learning may control the influence of historical data on parameters of the machine learning model. This may be beneficial in scenarios where data arrives sequentially, and the machine learning model needs to adapt continually without retaining gradients from past data. For example, the counter management device (or another device) may discard one or more gradients calculated for a current data point without incorporating them into the machine learning model. This may enable more weight to be given to recent data and reduce the influence of older data. In other examples, the one or more sequential learning operations may include determining new gradients and/or updating the gradients of the machine learning model using the feedback data.

In some implementations, the counter management device (or another device) may update the gradients of the machine learning model using the feedback data (e.g., as new feedback data is stored for the machine learning model). Based on detecting the training event, the counter management device (or another device) may cause the one or more gradients to be reset (e.g., to give more weight to newer data).

As indicated above, FIGS. 1A-1C are provided as an example. Other examples may differ from what is described with regard to FIGS. 1A-1C.

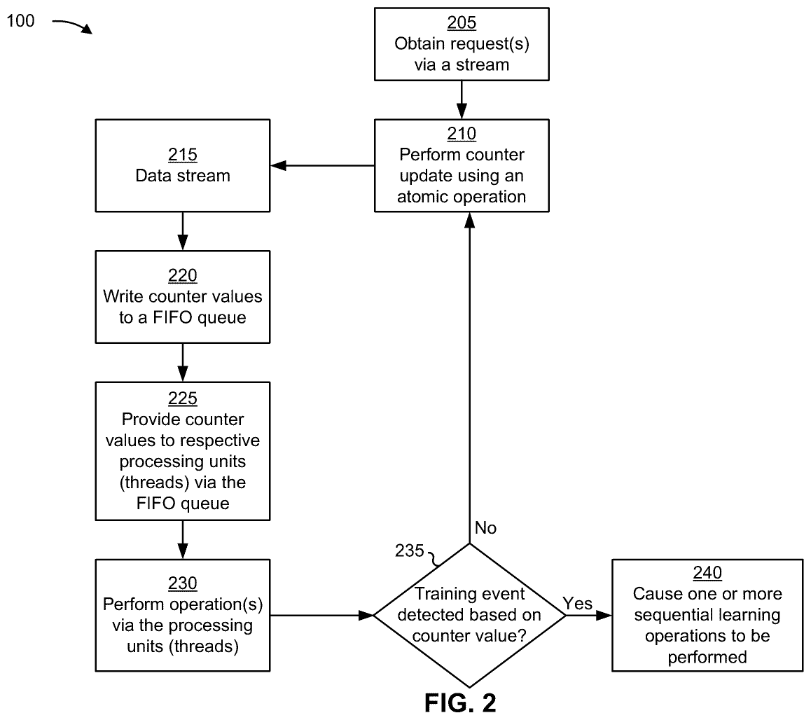

FIG. 2 is a diagram of an example process 200 associated with maintaining sequentiality for a counter for sequential learning. As shown in FIG. 2, the process 200 may include one or more operations. The process 200 may be performed by one or more devices, such as the counter management device described elsewhere herein.

As shown in FIG. 2, the process 200 may include obtaining one or more requests via a stream (block 205). For example, the counter management device may obtain the one or more requests via the stream (e.g., a request stream or feedback stream). A request may be associated with an operation for a field or entry in a distributed database. The process 200 may include performing a counter update using an atomic expression (block 210). For example, counter management device may perform a counter update using an atomic expression. As an example, a counter value may be stored as an atomic number. The counter management device may update, for each request, the counter value using an update expression. This may ensure that the counter value is updated for each request and that the counter value cannot be concurrently updated for multiple requests (e.g., ensuring that the same counter value is not stored for or associated with multiple requests).

The process 200 may include providing the updated counter value(s) to a data stream (block 215). For example, the counter management device may provide the updated counter value(s) to a data stream. As an example, the counter management device may create an event each time a new counter value is updated or generated. The event may cause the counter value to be provided to a data stream (e.g., via a serverless function). The process 200 may include writing the counter values to a FIFO queue (block 220). For example, the counter management device may write the counter values to the FIFO queue. The FIFO queue may serve as a “pass through” layer (or a buffer layer) for the counter values to ensure the sequentiality of the counter values is maintained. As an example, providing the counter values to the data stream may cause the counter values to be streamed to the FIFO queue and written in the order in which the counter values are updated (e.g., to ensure that the counter values are written in the FIFO queue sequentially).

The process 200 may include providing counter values to respective processing units (e.g., threads) via the FIFO queue (block 225). For example, the counter management device may provide the counter values to respective processing units (e.g., threads) via the FIFO queue. The processing units may obtain the counter values from a distributed database as indicated via the FIFO queue. For example, a processing unit may be configured to obtain a counter value from the distributed database when performing an operation indicated by a given request. The FIFO queue may be configured to provide an indication of counter values to be retrieved in the order in which the counter values are written to the FIFO queue. As a result, each operation may be associated with a sequential and/or unique counter value. The process 200 may include performing one or more operations via the processing units (block 230). For example, the processing units may be configured to perform respective operations. As an example, a processing unit may perform an operation and store data in a distributed database in connection with a given counter value obtained from the FIFO queue. The data may include feedback data for a machine learning model.

The process 200 may include determining whether a training event is detected based on the counter value (block 235). For example, the counter management device may determine whether a training event is detected based on the counter value. For example, the counter management device may monitor a current counter value and determine whether a training event is detected based on the current counter value. As an example, the training event may include the counter value satisfying a threshold. In some implementations, the threshold may include multiple values where the multiple values are multiples of a given value (e.g., if the given value is 100, the multiple values may include 100, 200, 300, 400, and so on). As another example, the training event may include the current counter value being a multiple of the given value. If the counter management device determines that the training event is not detected (block 235—No), then the counter management device may continue to perform counter updates and other operations described herein.

If the counter management device determines that the training event is not detected (block 235—No), then the process 200 may include causing one or more sequential learning operations to be performed (block 240). For example, the counter management device may cause one or more sequential learning operations to be performed based on detecting the training event. As described in more detail elsewhere herein, the one or more sequential learning operations may include updating one or more parameters of the machine learning model (e.g., a precision parameter and/or mean parameter) using the feedback data, and/or resetting one or more gradients of the machine learning model, among other examples.

As indicated above, FIG. 2 is provided as an example. Other examples may differ from what is described with regard to FIG. 2.

FIG. 3 is a diagram of an example environment 300 in which systems and/or methods described herein may be implemented. As shown in FIG. 3, environment 300 may include a distributed environment 301, which may include one or more elements of and/or may execute within a cloud computing system 302. The cloud computing system 302 may include one or more elements 303-312, as described in more detail below. As further shown in FIG. 3, environment 300 may include a network 320, and a counter management device 330. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an AMAZON WEB SERVICES platform, a MICROSOFT AZURE platform, or a SNOWFLAKE platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the distributed environment 301 may include one or more elements 303-312 of the cloud computing system 302, may execute within the cloud computing system 302, and/or may be hosted within the cloud computing system 302, in some implementations, the distributed environment 301 may not be cloud-based (e.g., may be implemented outside of a cloud computing system) or may be partially cloud-based. For example, the distributed environment 301 may include one or more devices that are not part of the cloud computing system 302, such as device 400 of FIG. 4, which may include a standalone server or another type of computing device. The distributed environment 301 may perform one or more operations and/or processes described in more detail elsewhere herein.

In some examples, the distributed environment 301 may include one or more cores (e.g., a processing unit within a central processing unit (CPU). Each core may be separate and independent processing unit capable of executing instructions and performing computations. In some examples, the distributed environment 301 may include a large quantity of cores. The large quantity of cores may increase a likelihood of concurrent operations being performed by respective cores.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The counter management device 330 may include one or more devices capable of receiving, generating, storing, processing, providing, and/or routing information associated with maintaining sequentiality for a counter for sequential learning, as described elsewhere herein. The counter management device 330 may include a communication device and/or a computing device. For example, the counter management device 330 may include a server, such as an application server, a client server, a web server, a database server, a host server, a proxy server, a virtual server (e.g., executing on computing hardware), or a server in a cloud computing system. In some implementations, the counter management device 330 may include computing hardware used in a cloud computing environment, such as the distributed environment 301.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with maintaining sequentiality for a counter for sequential learning. The device 400 may correspond to the distributed environment 301, a component included in the distributed environment 301, and/or the counter management device 330. In some implementations, the distributed environment 301, a component included in the distributed environment 301, and/or the counter management device 330 may include one or more devices 400 and/or one or more components of the device 400. As shown in FIG. 4, the device 400 may include a bus 410, a processor 420, a memory 430, an input component 440, an output component 450, and/or a communication component 460.

The bus 410 may include one or more components that enable wired and/or wireless communication among the components of the device 400. The bus 410 may couple together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 may include a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 may include one or more processors capable of being programmed to perform one or more operations or processes described elsewhere herein.

The memory 430 may include volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 may store information, one or more instructions, and/or software (e.g., one or more software applications) related to the operation of the device 400. In some implementations, the memory 430 may include one or more memories that are coupled (e.g., communicatively coupled) to one or more processors (e.g., processor 420), such as via the bus 410. Communicative coupling between a processor 420 and a memory 430 may enable the processor 420 to read and/or process information stored in the memory 430 and/or to store information in the memory 430.

The input component 440 may enable the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 may enable the device 400 to provide output, such as via a display, a speaker, and/or a light-emitting diode. The communication component 460 may enable the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

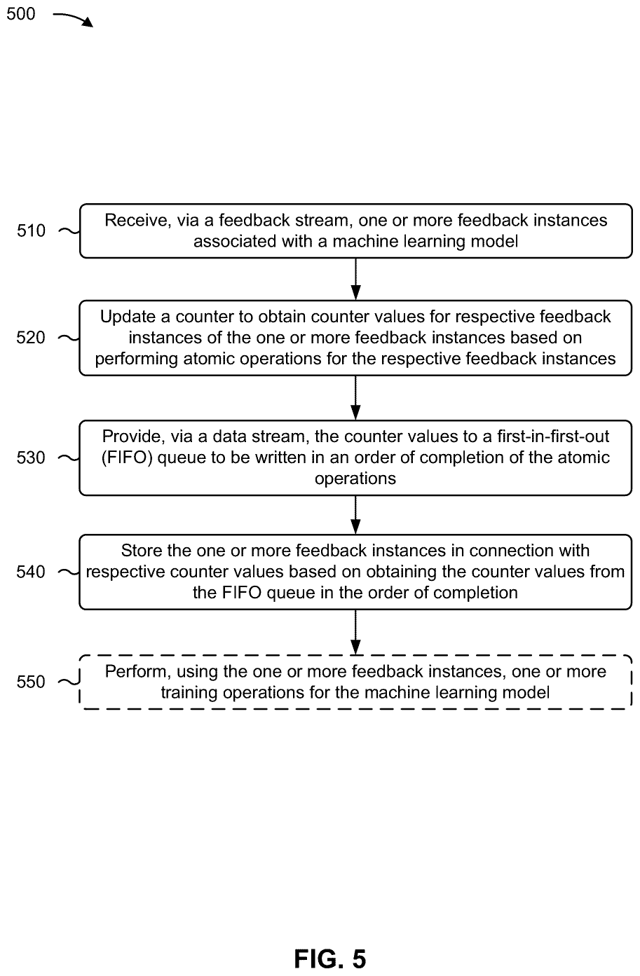

FIG. 5 is a flowchart of an example process 500 associated with maintaining sequentiality for a counter for sequential learning. In some implementations, one or more process blocks of FIG. 5 may be performed by the counter management device 330. In some implementations, one or more process blocks of FIG. 5 may be performed by another device or a group of devices separate from or including the counter management device 330, such as one or components of the distributed environment 301. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, via a feedback stream, one or more feedback instances associated with a machine learning model (block 510). For example, the counter management device 330 (e.g., using processor 420, memory 430, input component 440, and/or communication component 460) may receive, via a feedback stream, one or more feedback instances associated with a machine learning model, as described above in connection with reference number 105 of FIG. 1A. As an example, the counter management device 330 may obtain one or more requests associated with storing or providing respective feedback instances of the one or more feedback instances in a distributed database to be used for sequential learning associated with the machine learning model.

As further shown in FIG. 5, process 500 may include updating a counter to obtain counter values for respective feedback instances of the one or more feedback instances based on performing atomic operations for the respective feedback instances (block 520). For example, the counter management device 330 (e.g., using processor 420 and/or memory 430) may update a counter to obtain counter values for respective feedback instances of the one or more feedback instances based on performing atomic operations for the respective feedback instances, as described above in connection with reference number 110 of FIG. 1A. As an example, the atomic operations may include using an update expression to update an atomic number indicating the counter value. An “atomic” operation may refer to an operation that is indivisible, unchangeable, and guaranteed to be executed without interruption by other operations.

As further shown in FIG. 5, process 500 may include providing, via a data stream, the counter values to a FIFO queue to be written in an order of completion of the atomic operations (block 530). For example, the counter management device 330 (e.g., using processor 420 and/or memory 430) may provide, via a data stream, the counter values to a FIFO queue to be written in an order of completion of the atomic operations, as described above in connection with reference number 115 of FIG. 1B. As an example, the counter management device 330 may cause updated counter values to be streamed to the FIFO queue in the order. For example, each time the counter value is updated, the counter management device 330 may create an event. The event may trigger a function (e.g., an anonymous function or a serverless function) to stream the counter value to the FIFO queue.

As further shown in FIG. 5, process 500 may include storing the one or more feedback instances in connection with respective counter values based on obtaining the counter values from the FIFO queue in the order of completion (block 540). For example, the counter management device 330 (e.g., using processor 420 and/or memory 430) may store the one or more feedback instances in connection with respective counter values based on obtaining the counter values from the FIFO queue in the order of completion, as described above in connection with reference number 120 of FIG. 1B. As an example, the counter management device 330 may cause the feedback instances to be stored in connection with respective counter values based on providing counter values from the FIFO queue to processing units (e.g., threads) that are associated with executing one or more operations associated with the feedback instances.

As further shown in FIG. 5, process 500 may optionally include performing, using the one or more feedback instances, one or more training operations for the machine learning model (block 550). For example, the counter management device 330 (e.g., using processor 420 and/or memory 430) may perform, using the one or more feedback instances, one or more training operations for the machine learning model, as described above in connection with reference number 145 and/or reference number 150 of FIG. 1C. As an example, the counter management device 330 may detect a training event based on a current counter value. The counter management device 330 may cause the one or more training operations for the machine learning model to be performed based on detecting the training event. The one or more training operations may include online sequential learning operations for the machine learning model.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1C and/or 2. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for maintaining sequentiality for a counter for sequential learning, the system comprising:
one or more memories; and
one or more processors, communicatively coupled to the one or more memories, configured to:
receive, via a feedback stream, one or more requests to perform respective operations for feedback data associated with a machine learning model,
wherein processing units are associated with respective requests of the one or more requests and are configured to perform the respective operations;
update, via a counter database, the counter to obtain counter values for the respective requests of the one or more requests based on performing atomic operations for the respective requests;
provide, from the counter database and via a data stream, the counter values to a first-in-first-out (FIFO) queue to be written in an order of completion of the atomic operations;
store the feedback data in connection with respective counter values based on providing the counter values from the FIFO queue to the processing units in the order of completion; and
perform, using the feedback data, one or more training operations for the machine learning model based on a counter value, of the counter values, satisfying a threshold.

2. The system of claim 1, wherein the one or more training operations are associated with sequential unsupervised learning for the machine learning model.

3. The system of claim 1, wherein the counter values are unique identifiers for respective sets of feedback data included in the feedback data to maintain a sequentiality of the feedback data.

4. The system of claim 1, wherein the one or more processors, to perform the one or more training operations, are configured to:
update, using the feedback data, at least one of one or more precision metrics or a mean value associated with the machine learning model; and
reset one or more gradients of the machine learning model.

5. The system of claim 1, wherein the one or more processors, to update the counter, are configured to:
perform, for each request of the one or more requests, an atomic increment using an atomic number as a current counter value of the counter and an expression to obtain a counter value for that request.

6. The system of claim 1, wherein the one or more processors are further configured to:
perform, via the processing units and based on providing the counter values from the FIFO queue to the processing units in the order of completion, the respective operations for feedback data to cause the feedback data to be stored.

7. The system of claim 6, wherein the respective operations are concurrent operations.

8. The system of claim 1, wherein the one or more processors, to perform the one or more training operations, are configured to:
perform the one or more training operations based on a sequential order of the feedback data indicated by the counter values.

9. A method for maintaining sequentiality for feedback for sequential learning, comprising:
receiving, by a device and via a feedback stream, one or more feedback instances associated with a machine learning model;
updating, by the device, a counter to obtain counter values for respective feedback instances of the one or more feedback instances based on performing atomic operations for the respective feedback instances;
providing, by the device and via a data stream, the counter values to a first-in-first-out (FIFO) queue to be written in an order of completion of the atomic operations;
storing, by the device, the one or more feedback instances in connection with respective counter values based on obtaining the counter values from the FIFO queue in the order of completion; and
performing, by the device and using the one or more feedback instances, one or more training operations for the machine learning model.

10. The method of claim 9, wherein performing the one or more training operations comprises:
performing one or more sequential learning operations based on a sequentiality indicated by the counter values.

11. The method of claim 9, wherein the one or more training operations are associated with sequential unsupervised learning for the machine learning model.

12. The method of claim 9, wherein updating the counter comprises:
performing a counter update using an expression function and an atomic value,
wherein the atomic value is a current counter value of the counter.

13. The method of claim 9, wherein performing the one or more training operations is based on a counter value, of the counter values, satisfying a threshold.

14. The method of claim 9, wherein the counter values are unique identifiers for respective feedback instances of the one or more feedback instances to maintain a sequentiality of the one or more feedback instances.

15. The method of claim 9, wherein performing the one or more training operations comprises:
updating, using the one or more feedback instances, at least one of one or more precision metrics or a mean value associated with the machine learning model; and
resetting one or more gradients of the machine learning model.

16. A non-transitory computer-readable medium storing a set of instructions, the set of instructions comprising:
one or more instructions that, when executed by one or more processors of a device, cause the device to:
obtain, via a request stream, one or more requests associated with a data element included in a distributed database,
wherein processing units of the device are associated with respective requests of the one or more requests and are configured to perform the one or more requests;
update, for each request of the one or more requests, a counter to obtain a counter value for that request based on performing an atomic operation associated with the counter for that request;
provide, via a data stream, counter values to a first-in-first-out (FIFO) queue to be written sequentially in accordance with an order of counter values;
provide, from the FIFO queue and in the order, the counter values to respective processing units of the processing units; and
perform, via the processing units, one or more operations associated with the respective requests based on providing the counter values.

17. The non-transitory computer-readable medium of claim 16, wherein the one or more requests are associated with respective feedback instances that are associated with sequential learning for a machine learning model.

18. The non-transitory computer-readable medium of claim 17, wherein the one or more operations are associated with storing respective feedback instances, and wherein the one or more instructions further cause the device to:
perform, using the respective feedback instances, one or more sequential learning operations.

19. The non-transitory computer-readable medium of claim 16, wherein the counter values are unique identifiers for the respective requests indicating a sequentiality of the one or more requests based on the order of the counter values.

20. The non-transitory computer-readable medium of claim 16, wherein the one or more instructions, that cause the device to update the counter, cause the device to:
perform, for each request of the one or more requests, an atomic increment using an atomic number as a current counter value of the counter and an expression function to obtain a counter value for that request.
